(19) United States
(12) Patent Application Publication
(10) Pub. No.: US 2026/0094049 A1
(43) Pub. Date: Apr. 2, 2026

(54) Identifying Flows in AI Algorithms

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); MANISH MARWAH, Pleasanton, CA (US)

(73) Assignee: MICRO FOCUS LLC, WILMINGTON, DE (US)

(21) Appl. No.: 18/899,591

(22) Filed: Sep. 27, 2024

(51) Int. Cl. G06N 20/00

(52) U.S. Cl. CPC G06N 20/00

(57) ABSTRACT

Vectors of a target AI algorithm are captured by a trained flow AI algorithm. The trained flow AI algorithm is trained based on a training set of flows of vectors associated with a specific type of output data from the target AI algorithm. For example, the specific type of output data from the target AI algorithm may be a link to a malicious website. A flow of vectors in the target AI algorithm is identified by the trained flow AI algorithm based on the training set of flows of vectors associated with the specific type of output data from the target AI algorithm. In response to identifying the flow of vectors in the target AI algorithm, an action is taken. For example, the action may be to remove the link to the malicious website from the specific type of output data from the target AI algorithm.

### BACKGROUND

The disclosure relates generally to Artificial Intelligence (AI) algorithms and particularly to identifying flows of vectors and/or tensors within a neural network of an AI algorithm.

Many AI algorithms are trained with large training sets that can include data that may generate malicious output data. Current solutions are limited in how the malicious output data is identified.

### SUMMARY

These and other needs are addressed by the various embodiments and configurations of the present disclosure. The present disclosure can provide a number of advantages depending on the particular configuration. These and other advantages will be apparent from the disclosure contained herein.

Vectors of a target AI algorithm are captured by a trained flow AI algorithm. The trained flow AI algorithm is trained based on a training set of flows of vectors associated with a specific type of output data from the target AI algorithm. For example, the specific type of output data from the target AI algorithm may be a link to a malicious website. A flow of vectors in the target AI algorithm is identified by the trained flow AI algorithm based on the training set of flows of vectors associated with the specific type of output data from the target AI algorithm. In response to identifying, the flow of vectors in the target AI algorithm, an action is taken. For example, the action may be to remove the link to the malicious website from the specific type of output data from the target AI algorithm or to block the specific type of output data from the target AI algorithm.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for identifying a flow of vectors in a target AI algorithm.

FIG. 2 is a block diagram of a neural network of a target AI algorithm.

FIG. 3 is a block diagram of a process for training a flow AI algorithm.

FIG. 4 is a block diagram of a process for capturing a flow of vectors in a target AI algorithm.

FIG. 5A is a block diagram of a captured flow of vectors from an input node to an output node in a neural network of a target AI algorithm.

FIG. 5B is a block diagram of a captured flow of vectors through parallel nodes in a neural network of a target AI algorithm.

FIG. 5C is a block diagram of a captured flow of vectors that have separate paths in a neural network of a target AI algorithm.

FIG. 6 is a block diagram of a system for taking an action based on identifying a flow of vectors in a target AI algorithm.

FIG. 7 is a flow diagram of a process for training a flow AI algorithm.

FIG. 8 is a flow diagram of a process capturing a flow of vectors in a target AI algorithm.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

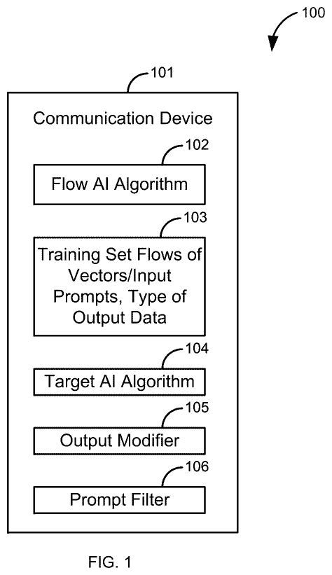

FIG. 1 is a block diagram of a first illustrative system 100 for identifying a flow of vectors in a target AI algorithm 104. The first illustrative system 100 comprises a communication device 101.

The communication device 101 can be or may include any type of communication device 101 such as a Personal Computer (PC), a telephone, a video system, a cellular telephone, a Personal Digital Assistant (PDA), a tablet device, a notebook device, a laptop computer, a smartphone, a server, a networked device, an embedded device, a cloud service, and/or the like. Although not shown, the communication device 101 may be connected to a network, such as the Internet, a Wide Area Network (WAN), a Local Area Network (LAN), a packet switched network, a circuit switched network, a cellular network, a combination of these, and the like. Users may access the communication device 101 via the network. The communication device 101 comprises a flow AI algorithm 102, a training set of flows of vectors/input prompts for a type of output data 103, a target AI algorithm 104, an output modifier 105, and a prompt filter 106.

The flow AI algorithm 102 is trained based on the training set of flows of vectors/input prompts for a type of output data 103. The flow AI algorithm 102 captures vectors that flow between nodes of a neural network of the target AI algorithm 104 to identify specific flows of vectors that match a flow of vectors that produces a specific type of output in the target AI algorithm 104. For example, the specific type of output may be a malicious output, such as a link to a malicious web site or source code that contains a vulnerability (e.g., a backdoor password).

The target AI algorithm 104 is an AI algorithm that is being used to produce output data. The target AI algorithm 104 uses a neural network that uses vectors and weights to produce the output data.

The output modifier 105 monitors the output data of the target AI algorithm 104 and identifies output data that may want to be modified and/or filtered out. The modified/filtered output data may be modified based on input/control from the flow AI algorithm 102.

The prompt filter 106 monitors the input prompts to the target AI algorithm 104 to identify specific input prompts that may need to be filtered out and/or modified. The prompt filter 106 may filter out/modify input prompts based on input from the flow AI algorithm 102.

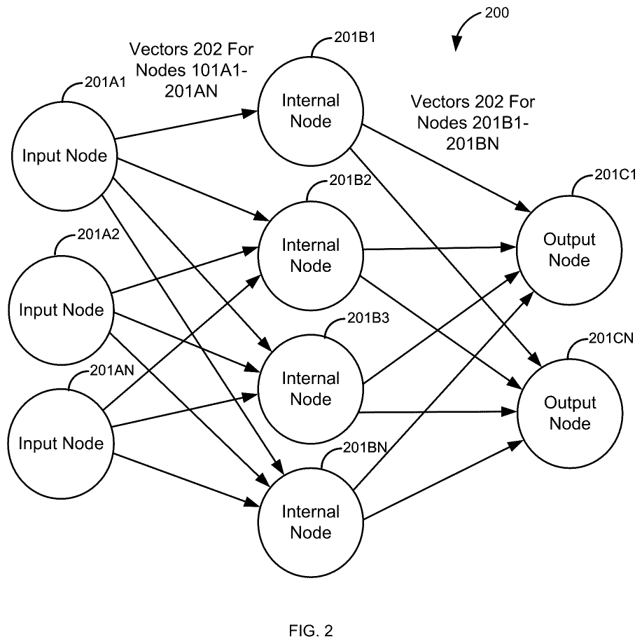

FIG. 2 is a block diagram of a neural network 200 of a target AI algorithm 104. The neural network 200 comprises input nodes 201A1-201AN, internal nodes 201B1-201BN, and output nodes 201C1-201CN. The input nodes 201A1-201AN are connected via vectors 202 (shown by the arrows) to the internal nodes 201B1-201BN. The input nodes 201A1-201AN are used to take input tokens (e.g., text input prompts that have been broken into chunks). The internal nodes 201B1-201BN are connected to the output nodes 201C1-201CN via vectors 202 (shown by the arrows). A vector 202 is mathematical representation of data being passed between the nodes 201. A vector 202 may be a number (e.g., a floating-point number, an integer, and/or the like), multiple numbers (e.g., an array of numbers), a multi-dimensional vector (e.g. a tensor), and/or the like.

The neural network 200 of FIG. 2 is an exemplary neural network 200 that is used for illustrative purposes. Typically, the neural network 200 for the target AI algorithm will be much larger. For example, many of the modern-day neural networks 200 comprise billions of nodes 201, hundreds of layers, and billions or tens of billions of vectors 202. The neural network 200 may have various architectures, such as, a fully connected architecture (similar to FIG. 2), a transformer, a convolutional neural network, a recurrent neural network, and/or the like.

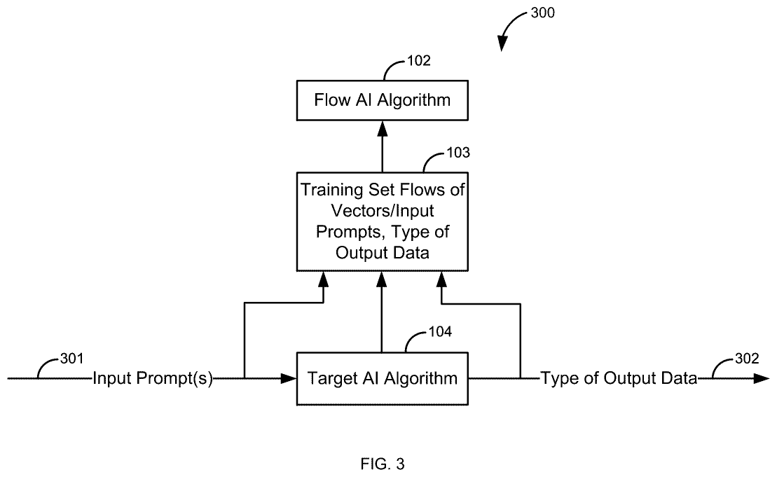

FIG. 3 is a block diagram of a process for training a flow AI algorithm 102. The training set of flows of vectors/input prompts 103 for a type of output data 302 consists of input prompts 301 that generate a specific type of output data 302, captured vectors 202 of the target AI algorithm 104 based on the input prompts 301 that generate the type of output data 302, and the type of output data 302.

The training set of flows of vectors/input prompts for a type of output data 103 allow the flow AI algorithm 102 to be able to identify flows of vectors 202 that are likely to generate the type of output data 302. The specific type of output data 302 may be a malicious type of output data 302, such as malicious source code, phishing emails, malicious links, viruses, information about a nefarious activity, vulnerabilities in source code, and/or the like. Alternatively, the type of output data 302 may be positive or a neutral type of output data 302. For example, the type of output data 302 may be positive reviews about a specific website, positive output data about a particular person, information about a website, information about a product, and/or the like. In other words, the specific type of output data 302 of the target AI algorithm 104 can be distinguished from other types of output data that the flow AI algorithm 102 is not looking for.

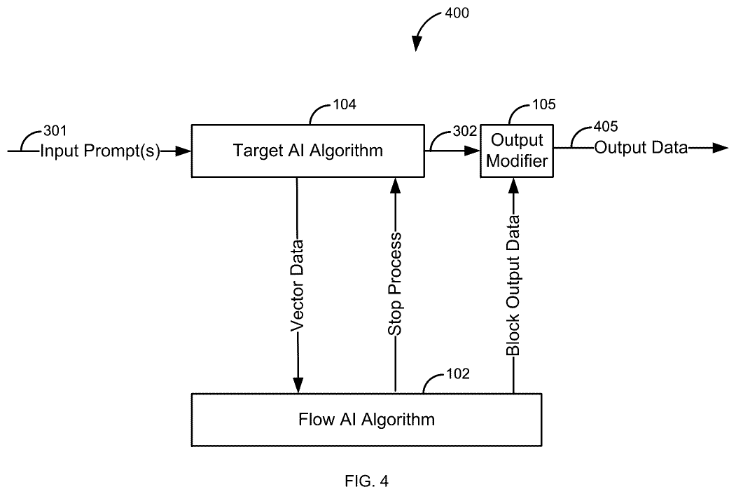

FIG. 4 is a block diagram of a process for capturing a flow of vectors in a target AI algorithm 104. The input prompt(s) 301 are input to the target AI algorithm's 104 input nodes 201A1-201AN, for example, by tokenizing the input prompt(s) 301 into tokens (e.g., chunks). While the input prompt(s) 301 are input to the target AI algorithm 104, the trained flow AI algorithm 102 monitors the vectors 202 that are passed between the nodes 201 in the neural network 200. For example, the flow AI algorithm 102 may hook each of the vectors 202 (which could be billions). The hooking (placing code that can monitor a vector) may be where there is a small amount of source code that captures the data of the vectors 202. The flow AI algorithm 102, upon detecting a flow of vectors (e.g., a matching set of vectors 202 between specific nodes 201), may take an action. For example, the action may be to modify type of output data 302 from the target AI algorithm 104 using the output modifier 105, block the type of output data 302 from the target AI algorithm 104 to only produce output data 405, stop the target AI algorithm 104 from completing the processing of an input prompt(s) 301, identify a user of the input prompt(s) 301, and/or the like.

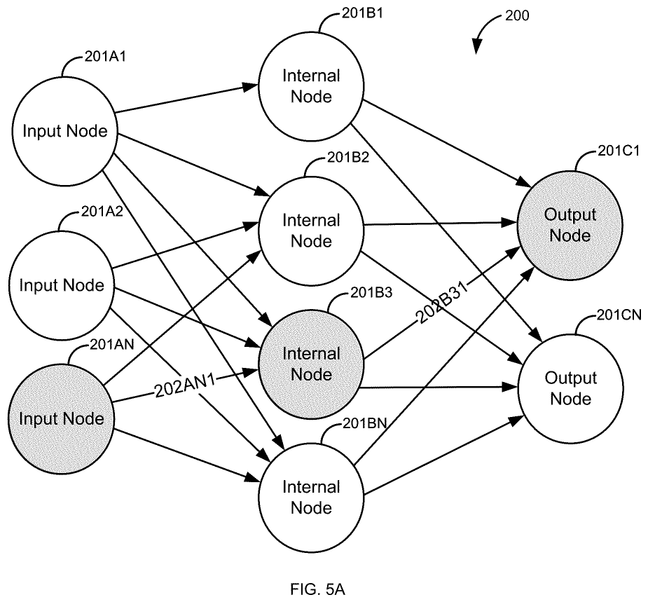

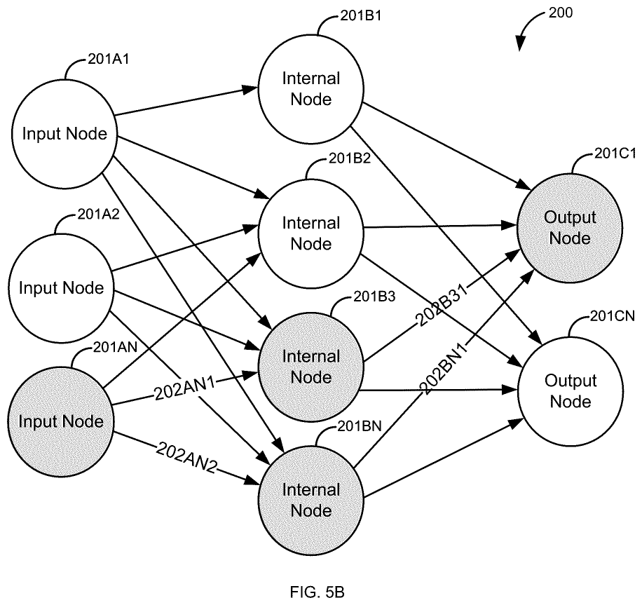

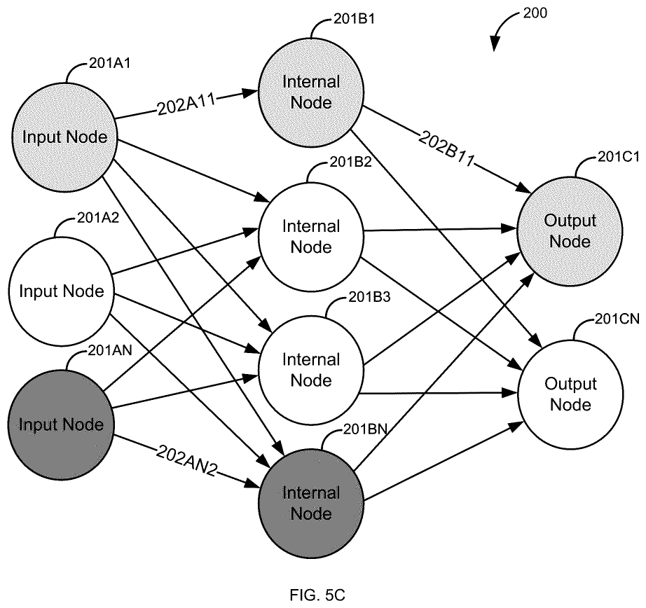

FIG. 5A is a block diagram of a captured flow of vectors (indicated by the darker nodes 201AN, 201B3, and 201C1) from input nodes 201A1-201AN to the output nodes 201C1-201CN in the neural network 200 of a target AI algorithm 104. The flow AI algorithm 102 may identify different types of flows of vectors. For example, as shown in FIG. 5A, the flow of vectors from the input node 201AN (via the vector 202AN1) to the internal node 201B3 and the flow from the internal node 201B3 (via vector 202B31) to the output node 201C1 is identified as a malicious flow that produces a malicious type of output data 302X based on the training set of flows of vectors/input prompts for a type of output data 103. In this example, the identified flow of vectors would be the vectors 202AN1 and 202B31.

The identified malicious flow consists of the vectors 202AN1 and 202B31, which are numeric values. The numeric values of the vectors 202AN1 and 202B31 may be identified based identical vectors 202, based on a specific variance from a learned vector 202 values/combination of vector values identified from the training set of flows of vectors/input prompts for a type of output data 103. While FIG. 5A shows an exemplary malicious flow of vectors that goes from the input node 201AN to the output node 201C1, the flow of vectors may be based on a partial flow. For example, a large neural network 200 may include billions of nodes 201 and hundreds of layers. A flow of vectors may be based on a flow from an input node 201 to an internal node 201 that is in the 68^{th} layer of the target AI algorithm 104. The captured flow of vectors may start at an internal node 201 and go to an output node 201. A captured flow of vectors may be between internal nodes 201.

FIG. 5B is a block diagram of a captured flow of vectors (indicated by the darker nodes 201AN, 201B3, 201BN, and 201C1) through parallel nodes 201B3/201BN in the neural network 200 of a target AI algorithm 104. FIG. 5B shows a flow of vectors that comprises multiple flows of vectors (i.e., where there are multiple parallel vectors 202 (e.g., the vectors 202AN1/202AN2 and the vectors 202B31/202BN1) that are part of the flow of vectors. In FIG. 5B, the identified flow of vectors is from the input node 201AN via vectors 202AN1/202AN2 to the internal nodes 201B3/201BN, from the internal nodes 201B3/201BN via vectors 202B31/202BN1 to the output node 201C1. The flow of vectors of FIG. 5B shows an identified flow of vectors from the input node 201AN to the output node 201C1 like in FIG. 5A. However, the identified flow of vectors in FIG. 5B includes not only the vectors 202AN1/202B31, but also the vectors 202AN2/202BN1.

FIG. 5C is a block diagram of a captured flow of vectors (indicated by the darker nodes 201A1, 202B1, 201C1, 201AN, and 201BN) that have separate paths in a neural network 200 of the target AI algorithm 104. A captured flow of vectors may be based on two or more separate flows of vectors that produce a type of output data 302. FIG. 5C illustrates an example of a flow of vectors that is based on two separate flows of vectors. In FIG. 5C, the flow of vectors comprises the flow from the input node 201A1, internal node 201B1, and output node 201C1 that use the vectors 202A11 and 202B11 along with the flow of vectors from the input node 201AN to internal node 201BN that uses the vector 202AN2. In this example, the flow of vectors comprises the vectors 202A11, 202B11, and 202AN2.

The examples of FIGS. 5A-5C are for a specific type of output data 302. The flow AI algorithm 102 may be able to identify multiple different flow patterns of vectors for different types of output data 302 at the same time. For example, FIG. 5C may identify two completely different malicious flows that are not related to each other. The flow of vectors from the input node 201A1 to the output node 201C (vectors 202A11/202B11) may be a first malicious flow of vectors for the malicious output data 302X (e.g., the generation of a malicious link) and the flow of vectors from the input node 201AN to internal node 201BN (vector 202AN2) may be associated with a second type of malicious output data 302Y (generation of a false type of output data 302).

One issue for looking at all the vectors 202 of the target AI algorithm 104 may be a size/performance issue. For example, if the target AI algorithm 104 being monitored comprises billions of nodes 201 and hundreds of layers, tracking all the vectors 202 of the neural network 200 of the target AI algorithm 104 in real-time may cause performance issues for the target AI algorithm 104. One solution to this problem is to identify specific flows in the target AI algorithm 104 that produce a specific type of output data 302. Once a flow of vectors is identified, only the specific vectors 202 of the flow of vectors needs to be captured. For example, if a malicious flow that comprises 428 vectors is identified, only the 428 vectors 202 of the billions of total vectors 202 in the target AI algorithm 104 may be captured in real-time. The flow AI algorithm 102 makes this process much more scalable and allows the flow AI algorithm 102 identify flows that produce benign or malicious output data much more efficiently than traditional methods.

Another approach to reduce the volume of flows is to use dimensionality reduction methods, such as Principal Component Analysis (PCA), autoencoders, and/or the like. For example, PCA may be used to identify important vectors 202 in the neural network 200 that make the most sense to capture (e.g., 100,000 vectors 202 versus 10 billion vectors 202). Since the number of flows available to predict whether a type of output data 302 would be produced is not exceptionally large, these mechanisms can be used to reduce number of vectors to capture in real-time. Given all the flows, the process may be used to 1) filter and retain flows from specific layers, 2) filter and retain flows related to specific tokens, and 3) collect all the remaining flows. This information can be input to identify the flow of the vectors 202 in the target AI algorithm 104, say from a binary classifier, which categorizes the flows of vectors into one of two categories—benign or malicious. However, the input would have extremely high dimensionality. For example, if n flows of vectors remain, and each flow vectors is 1024 in length, the total length becomes n*1024. The process can apply standard dimensionality methods to reduce the dimension from n*1024 to m, where m is much smaller. PCA is one of the simple methods for achieving this reduction in dimensionality. PCA is a linear method. Another is using an autoencoder, which is a neural network 200 for reducing dimensions and capturing non-linear dependencies.

Also, in addition to layers and tokens, there may be other criteria that can be used to filter the flows. In a transformer architecture, which is a large neural network 200, the entire context is a sequence that is processed in parallel. The number of tokens of the input prompt(s) 301 processed in parallel is called its context size. For example, if the context size is 4K then 4K tokens are processed in parallel. The sequence that is input is first converted to tokens, then at each layer these vectors 202 are transformed based on weights and interaction with other vectors 202. One can think of these vectors 202 flowing through the neural network 200 in parallel and getting transformed.

The input prompts 301 to flow AI algorithm 102 that determines type of output data 302, could potentially be the flows of all the vectors 202 at the output of each layer of nodes 201. So based on specific criteria the flow AI algorithm 102 can decide which layers and which vectors 202 within a layer to capture.

Monitoring the vectors 202 may be used to determine that the weights of the nodes 201 may have been maliciously changed. For example, the value of the weights may be captured and then compared to the current value of the weights when a flow of vectors is identified. The flow of vectors may also include the weights of the nodes 201 that are part of the flow of vectors.

In one embodiment, the malicious flows of vectors may be stored in a library of malicious flows of vectors similar to how virus patterns are stored. The malicious flows of vectors can then be used to monitor a copy of target AI algorithm 104 for the malicious flows of vectors. For example, if there are multiple instances of the target AI algorithm 104 (e.g., used by different entities), the malicious flows of vectors can be used to identify malicious flows of vectors in each of the instances of the target AI algorithm 104.

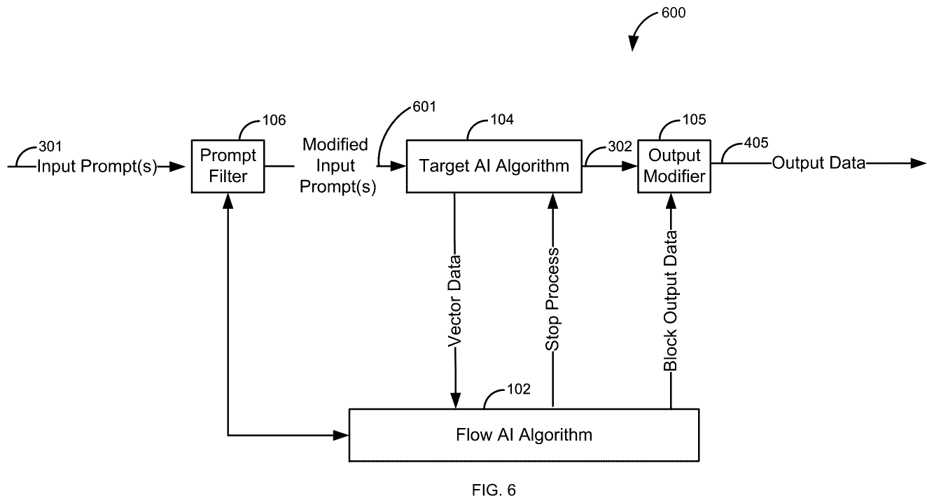

FIG. 6 is a block diagram of a system 600 for taking an action based on identifying a flow of vectors in a target AI algorithm 104. The identified flow of vectors can be tied back to an individual (e.g., a person)/process (e.g., a computer process/software application) that provided the input prompt(s) 301. Identification of specific flows of vectors can be used to identify specific input prompt(s) 301/users/sources that can then be filtered out/blocked via the prompt filter 106 in the future.

The prompt filter 106 may identify and filter out the specific input prompt(s) 301 based on input from the flow AI algorithm 102. In addition, the prompt filter 106 may block individual users/sources based on prior input prompt(s) 301 that are used for malicious or other types of activity. The prompt filter 106 may also identify input prompts 301 that are questionable and flag the user or source of the input prompt(s) 301 for further investigation. For example, the prompt filter 106 may modify an input prompt 301 to the target AI algorithm 104, block an input prompt(s) 301 to the target AI algorithm 104, identify an input prompt(s) 301 to the target AI algorithm 104, identify a source of the input prompt(s) 301 to the target AI algorithm 104 (e.g., a user or process), and/or the like.

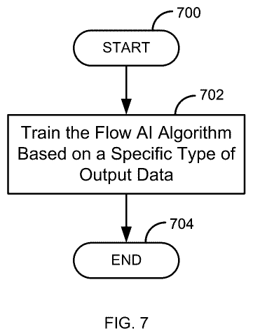

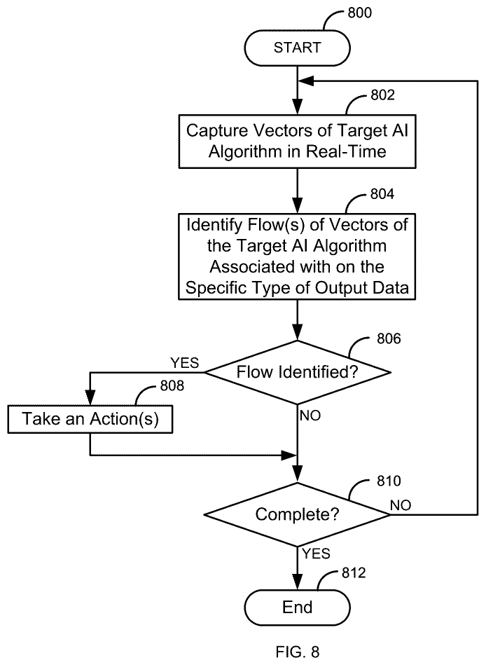

FIG. 7 is a flow diagram of a process for training a flow AI algorithm 102. Illustratively, the communication device 101, the flow AI algorithm 102, the target AI algorithm 104, the output modifier 105, the prompt filter 106, and the neural network 200 are stored-program-controlled entities, such as a computer or microprocessor, which performs the method of FIGS. 7-8 and the processes described herein by executing program instructions stored in a computer readable storage medium, such as a memory (i.e., a computer memory, a hard disk, and/or the like). Although the methods described in FIGS. 7-8 are shown in a specific order, one of skill in the art would recognize that the steps in FIGS. 7-8 may be implemented in different orders and/or be implemented in a multi-threaded environment. Moreover, various steps may be omitted or added based on implementation.

The process starts in step 700. The flow AI algorithm 102 is trained on the training set of flows of vectors/input prompt(s) 301 for a type of output data 103 in step 702. The process of step 702 may include the initial training and retraining (e.g., fine tuning) of the flow AI algorithm 102. In one embodiment, the training of the flow AI algorithm may only use the flow of vectors and type of output data 302. The process then ends in step 704.

FIG. 8 is a flow diagram of a process capturing a flow of vectors in a target AI algorithm 104. The process starts in step 800. The flow AI algorithm 102 captures vectors 202 of the target AI algorithm 104 in real-time in step 802. The captured vectors 202 of step 802 may be all the vectors 202 of the target AI algorithm 104 that are captured based on the input prompt(s) 301. Alternatively, the captured flow of vectors may be a subset of all the vectors 202 of the target AI algorithm 104. For example, specific identified flows of vectors (e.g., like those shown in FIGS. 5A-5C) may be captured by the flow AI algorithm 102, specific groups of vectors 202 identified using PCA analysis may be captured, specific groups of vectors 202 identified using an autoencoder may be captured, and/or the like.

The flow AI algorithm 102 identifies the flows of vectors of the target AI algorithm 104 associated with the specific type of output data 302 in step 804. For example, step 804 may identify a flow of vectors that goes through parallel nodes 201 like described in FIG. 5B. If a flow of vectors of the target AI algorithm 104 are identified in step 806, one or more actions are taken in step 808 and the process goes to step 810. If a flow is not identified in step 806, the process goes to step 810.

The flow AI algorithm 102 determines, in step 810, if the process is complete. If the process is not complete in step 810, the process goes back to step 802. Otherwise, the process ends in step 812.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
capture, by a trained flow Artificial Intelligence (AI) algorithm executed by the microprocessor, vectors of a target AI algorithm, wherein the trained flow AI algorithm is trained based on a training set of flows of vectors associated with a specific type of output data from the target AI algorithm;
identify, by the trained flow AI algorithm and based on the training set of flows of vectors associated with the specific type of output data from the target AI algorithm, a flow of vectors in the target AI algorithm; and
in response to identifying, based on the training set of flows of vectors associated with the specific type of output data from the target AI algorithm, the flow of vectors in the target AI algorithm, take an action.

2. The system of claim 1, wherein the training set of flows of vectors associated with the specific type of output data are associated with a malicious type of output data.

3. The system of claim 1, wherein the training set of flows of vectors associated with the specific type of output data also comprises a set of input prompts associated with the specific type of output data from the target AI algorithm.

4. The system of claim 1, wherein the action is at least one of: modifying the specific type of output data from the target AI algorithm, blocking the specific type of output data from the target AI algorithm, modifying an input prompt to the target AI algorithm, blocking an input prompt to the target AI algorithm, stopping the target AI algorithm from completing processing of an input prompt, and identifying a source of an input prompt to the target AI algorithm.

5. The system of claim 1, wherein the flow of vectors in the target AI algorithm comprises at least one of:
a flow of vectors from an input node to an output node;
a flow of vectors from internal node to an output node;
a flow of vectors from an input node to an internal node;
a flow of vectors from an internal node to an internal node;
a flow of vectors from an input node through two or more parallel nodes;
a flow of vectors from an internal node through two parallel nodes; and
a plurality of flows of vectors with a plurality of separate paths.

6. The system of claim 1, wherein identifying the flow of vectors in the target AI algorithm is based on capturing a subset of vectors of the target AI algorithm.

7. The system of claim 6, wherein the captured subset of vectors of the target AI algorithm are identified based on at least one of: specific flows between specific layers, flows related to specific tokens, specific identified flows, a binary classifier, a dimensionality, a Principal Component Analysis (PCA), and an autoencoder.

8. The system of claim 1, wherein the action is to check to see if any weights associated with the flow of vectors in the target AI algorithm have been changed.

9. The system of claim 1, wherein capturing the vectors of the target AI algorithm is done in real-time.

10. A method comprising:
capturing, by a trained flow Artificial Intelligence (AI) algorithm, vectors of a target AI algorithm, wherein the trained flow AI algorithm is trained based on a training set of flows of vectors associated with a specific type of output data from the target AI algorithm;
identifying, by the trained flow AI algorithm and based on the training set of flows of vectors associated with the specific type of output data from the target AI algorithm, a flow of vectors in the target AI algorithm; and
in response to identifying, based on the training set of flows of vectors associated with the specific type of output data from the target AI algorithm, the flow of vectors in the target AI algorithm, taking an action.

11. The method of claim 10, wherein the training set of flows of vectors associated with the specific type of output data are associated with a malicious type of output data.

12. The method of claim 10, wherein the training set of flows of vectors associated with the specific type of output data also comprises a set of input prompts associated with the specific type of output data from the target AI algorithm.

13. The method of claim 10, wherein the action is at least one of: modifying the specific type of output data from the target AI algorithm, blocking the specific type of output data from the target AI algorithm, modifying an input prompt to the target AI algorithm, blocking an input prompt to the target AI algorithm, stopping the target AI algorithm from completing processing of an input prompt, and identifying a source of an input prompt to the target AI algorithm.

14. The method of claim 10, wherein the flow of vectors in the target AI algorithm comprises at least one of:
a flow of vectors from an input node to an output node;
a flow of vectors from internal node to an output node;
a flow of vectors from an input node to an internal node;
a flow of vectors from an internal node to an internal node;
a flow of vectors from an input node through two or more parallel nodes;
a flow of vectors from an internal node through two parallel nodes; and
a plurality of flows of vectors with a plurality of separate paths.

15. The method of claim 10, wherein identifying the flow of vectors in the target AI algorithm is based on capturing a subset of vectors of the target AI algorithm.

16. The method of claim 15, wherein the captured subset of vectors of the target AI algorithm are identified based on at least one of: specific flows between specific layers, flows related to specific tokens, specific identified flows, a binary classifier, a dimensionality, a Principal Component Analysis (PCA), and an autoencoder.

17. The method of claim 10, wherein the action is to check to see if any weights associated with the flow of vectors in the target AI algorithm have been changed.

18. The method of claim 10, wherein capturing the vectors of the target AI algorithm is done in real-time.

19. A non-transient computer readable medium having stored thereon instructions that cause a microprocessor to execute a method, the method comprising instructions to:
capture, by a trained flow Artificial Intelligence (AI) algorithm executed by the microprocessor, vectors of a target AI algorithm, wherein the trained flow AI algorithm is trained based on a training set of flows of vectors associated with a specific type of output data from the target AI algorithm;
identify, by the trained flow AI algorithm and based on the training set of flows of vectors associated with the specific type of output data from the target AI algorithm, a flow of vectors in the target AI algorithm; and
in response to identifying, based on the training set of flows of vectors associated with the specific type of output data from the target AI algorithm, the flow of vectors in the target AI algorithm, take an action.

20. The non-transient computer readable medium of claim 19, wherein identifying the flow of vectors in the target AI algorithm is based on capturing a subset of vectors of the target AI algorithm.
